(19) United States
(12) Patent Application Publication
(10) Pub. No.: US 2013/0032210 A1
(43) Pub. Date: Feb. 7, 2013

(54) INTEGRATED MICROFLUIDIC DEVICE WITH ACTUATOR

(71) Applicants: Robert Johnstone, Montreal (CA); Stephane Martel, La Prairie (CA)

(72) Inventors: Robert Johnstone, Montreal (CA); Stephane Martel, La Prairie (CA)

(73) Assignee: TELEDYNE DALSA SEMICONDUCTOR, INC., Thousand Oaks, CA (US)

(21) Appl. No.: 13/196,385

(22) Filed: Aug. 2, 2011

(51) Int. Cl. F17D 1/00; B01L 3/00

(52) U.S. Cl. 137/1; 422/62; 422/502

(57) ABSTRACT

An integrated microfluidic device has at least at least one active element controlled by pneumatic signals, and at least one electrostatic actuator integrated in the device for generating the pneumatic signals within the device from an external supply of pressure or vacuum. In one embodiment the pressure supply may be generated internally on chip using an integrated pump.

### FIELD OF THE INVENTION

This invention relates to the field of microfluidic systems, and more particularly to the generation of pneumatic signals for such systems.

### BACKGROUND OF THE INVENTION

In microfluidic devices, such as lab-on-chip (LOC) devices, wherein analytical processes are performed within a microchip, fluidic components are required as is the case in their macroscopic counterparts. Important components, such as valves and pumps, are critical for successful operation of microfluidic devices. However, any components included in the final device must be compatible with the microfabrication process used in their construction. This has led to a situation in LOC devices where most valves and pumps are actuated using pneumatic signals, which are generated and controlled off-chip. In this approach, the manufacturing complexity of the actuation method does not impact the microfabrication techniques used in the construction of the LOC device.

Other actuation methods have been investigated, such as thermo-pneumatic and electrostatic actuation. These techniques are compatible with various microfabrication approaches, but have disadvantages such as increased fabrication complexity, limited performance, etc. For these reasons, current LOC practice continues to use off-chip pneumatic signals to drive actuation.

Nevertheless, as level of integration increases, the density of devices also increases, increasing the burden of chip-to-world interconnects. For example, every peristaltic pump requires at least three pneumatic ports plus their associated interconnection components to operate. These interconnects are manageable when there is a handful of pumps in an LOC, but become costly and cause reliability problems if their counts increase significantly. Improved actuation methods are required, but such methods not only need to be compatible with high-volume microfabrication techniques, but also require minimal complexity and consume minimal on-chip real-estate.

The pneumatic connections required by prior art devices limit the amount of functionality that can be integrated on-chip, increasing overall system costs. Additionally, as mechanical connections that must be set at time-of-use, pneumatic connections reduce reliability and increase the need for operator training.

### SUMMARY OF THE INVENTION

Embodiments of the invention employ a novel approach wherein pneumatic and electrostatic control takes place on the chip. Instead of having multiple pneumatic controls, as in the prior art, the microfluidic system in accordance with embodiments of the invention relies solely on a positive pressure supply, a negative pressure supply, or both. These system-wide pneumatic supplies can be routed over the entire chip, wherever they are required. Locally, compact electrostatic valves open or close to control the pressure in a particular line or chamber.

According to a broad aspect of the present invention there is provided an integrated microfluidic device, comprising at least one active element controlled by pneumatic signals; and at least one electrostatic actuator integrated in said device for generating the pneumatic signals within the device.

The pneumatic signals may be generated by an electrostatically controlled valve connected to at least one external pressure source. It will be understood in the context of this application that the term pressure source encompasses a source of either positive or negative pressure relative to ambient pressure, or it can just be a source of ambient pressure. It is a fixed supply as distinct from the pressure signals that are generated on chip.

The pneumatic signal generator (positive pressure or negative pressure coming from fixed external supplies) may be integrated in the valve design by two additional semi-active check valves. These two semi-active check valves are themselves entirely controlled electrically, allowing a full control of the fluidic valve from standard CMOS or high-voltage CMOS electronic. Embodiments of the invention therefore greatly reduce the pneumatic interconnections to the LOC, and increase the level of integration and autonomy of the LOC.

In a further aspect the invention provides a pneumatic signal generator, or in other words, a generator of compressed air supply and vacuum supply that may be integrated in the device. The pneumatic signal generator enables the elimination of the need for pneumatic connections to control fluidic valves and pumps integrated in a LOC. All the controls of the fluidic valves, which are still actuated by pneumatic signals, can be entirely converted to electrical signals, which can be controlled by standard CMOS or high voltage CMOS electronics. This allows a very high level of integration of the LOC.

The supply of compressed air may be considered analogous to the situation in microelectronics, where power is supplied externally, but individual components are turned on and off by signals generated internally. Microchips handle routing and control of power internally.

Embodiments of the invention make use of system-wide distribution of pneumatic signals within an integrated microfluidic device. Where positive or negative pneumatic controls are required, these are switched internally of the chip (integrated device).

### BRIEF DESCRIPTION OF THE DRAWINGS

The invention will now be described in more detail, by way of example only, with reference to the accompanying drawings, in which:

FIGS. 1A and 1B illustrate a prior art check valve in the open and closed positions;

FIGS. 2A and 2B depict a complex valve with an electrostatic actuator.

FIGS. 3A and 3B depict a pump with an electrostatic actuator; and

### DETAILED DESCRIPTION OF EMBODIMENTS OF THE INVENTION

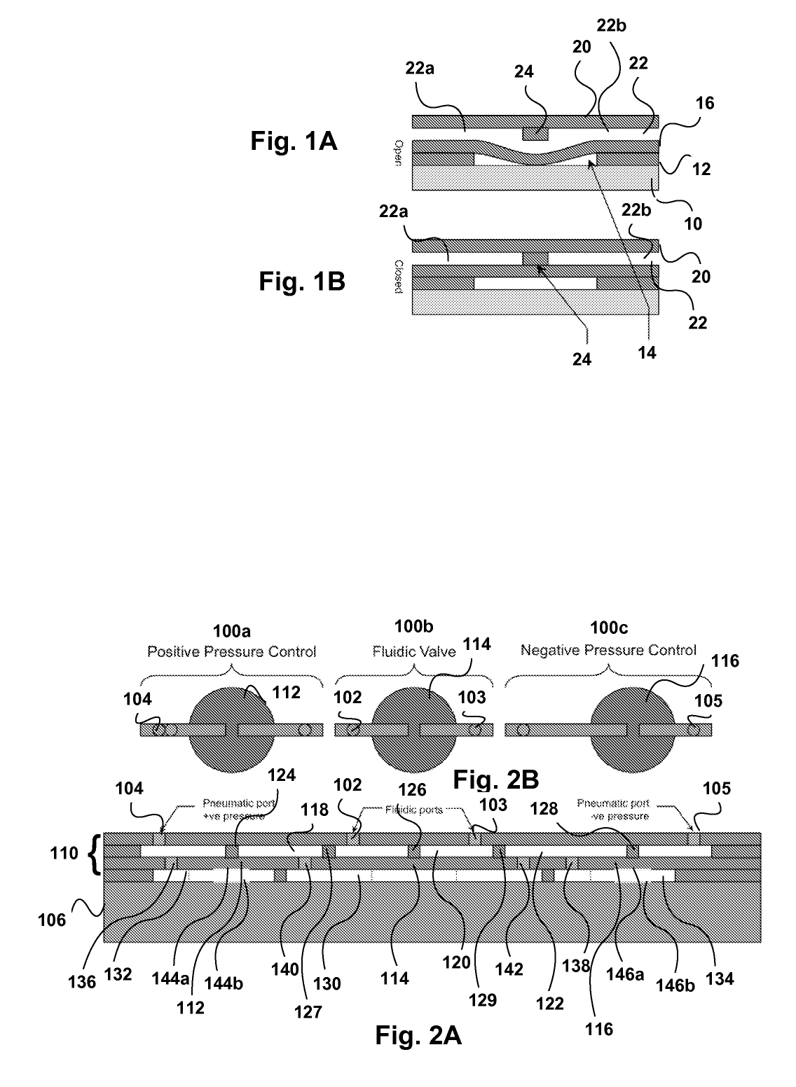

A prior art valve, known as a Mathies' valve, is shown in FIGS. 1A-1B, where FIG. 1A shows the valve in the open position and FIG. 1B shows the valve in the closed position. Such a valve is described in the paper by W. H. Grover et al. entitled “Monolithic Membrane Valves and Diaphragm Pumps for Practical Large-Scale Itegration in Glass Microfluidic devices” Sensors and Actuators B, vol. 89, no. 3, pg. 315-323 (2003), the contents of which are herein incorporated by reference. The valve consists of a substrate 10, a pneumatic layer 12 defining a chamber 14, a membrane layer 16, a cap layer 20 defining a fluid passage 22, and a barrier 24 separating the fluid passage 22 into parts 22a, 22b.

Etched into the fluid layer are channels (not shown) for water or some other liquid. An analyte for a chemical or medical application flows through these channels.

Etched into the pneumatic layer 12 are channels (not shown) for the pneumatic signals, which are either compressed air (positive gauge pressure) or vacuum (negative gauge pressure). The pneumatic channels are used to route these pressure signal to various locations around the device.

Between the fluid passage 22 and the pneumatic layer 12 is the membrane 16, fabricated typically in poly-dimethylsiloxane (PDMS) or other material. The imposition of vacuum (negative gauge pressure) through the channels carrying the pneumatic signals to the chamber creates a pressure difference across the membrane layer that causes the PDMS to deflect downwards, moving the membrane layer 16 away from the barrier 24 as shown in FIG. 1A. This movement creates an opening for the analyte to flow around the barrier. Consequently, a vacuum in the chamber 14 opens the valve. Conversely, compressed air (positive gauge pressure) in the chamber 14 creates a pressure difference across the membrane layer 16. This in turn causes the PDMS membrane 14 to deflect upwards, forcing the membrane against the barrier 24, and thus preventing the analyte from flowing through the passage 22. In order to create the pressure signals in the chamber 14, an external pneumatic connection to this chamber is required.

Broadly, embodiments of the invention include standard valve as show in FIGS. 1A-1B, wherein control signals deflect a membrane, which in turn opens or closes the valve are generated on chip. When a positive pressure is supplied to the chamber under the membrane, this forces the membrane upwards, and causes the valve to close, which prevents fluid (typically water or a water solution) from moving between the two sides. When a negative pressure is supplied, the membrane deflects downwards, and causes the valve to open, which allows the fluid to move between the two sides. In accordance with embodiments of the invention, instead of supplying all pneumatic control signals off-chip, those control signals are generated by pneumatic switches built on-chip.

The microfluidic chip has a positive pressure supply and a negative pressure supply. Both of these supplies are regulated at a fixed pressure, and distributed widely across the microfluidic chip. These supplies may be generated on-chip or off-chip. The goal is then to connect the chamber under a valve's membrane to the appropriate system wide supply.

In one embodiment the device contains two pneumatic ports, two fluidic ports, and two electrostatic actuators. For visualization, all of the pneumatic and fluidic ports are located on the top surface of the device. However, in an integrated LOC device, these connections would be routed in the chip.

The valve operates similarly to prior art valve. The relevant geometry is located in the centre of the design, where the two fluidic ports are located. As in the prior art valve, opening the valve involves deflecting the membrane upward or downward to control the area of the fluidic channel between the two fluidic ports.

In accordance with embodiments of the invention, the pneumatic signal used to control the fluidic valve is generated on-chip. In one example, the pneumatic signal is generated by controlling access to two system-wide pneumatic signals. However, the actuation chamber is isolated from these pressure supplies by check-valves. The check-valves are included such that their inlet is on the lower pressure side (reverse orientation). i.e. the valve will be closed. The valves also include electrodes so that the valves can be forced open. In this way, applying a voltage to the electrodes of the valve on the outlet side will connect the actuation chamber to the positive pressure supply, forcing the fluidic valve closed. Conversely, applying a voltage to the electrodes on the inlet side will connect the actuation chamber to the negative pressure supply, forcing the fluidic valve open.

Using the above approach, all of the pneumatic ports on a chip can be replaced by two—the positive and negative supplies. Further, since the pressure in those pneumatic supplies is fixed (i.e. does not vary during operation), all of the off-chip switches can be eliminated.

Further, the positive and negative supplies can be generated on-chip as well. Using check-valves and a reciprocating membrane, pumps that operate on air can be constructed on chip. This pump can be connected to atmosphere at one end and generate a positive or negative supply (depending on orientation) at the other end. This eliminates all need for off-chip pneumatic connections.

The advantage of this approach is that the supply pumps can consume significant area. Instead of creating two pneumatic pumps for each fluidic valve, two pumps supply the entire chip. The pumps can therefore be larger, more powerful, and more efficient, as these constraints are not multiplied by the number fluidic valves required.

In the preferred implementation, the pump uses an electrostatic actuator to reciprocate a membrane. The resulting system results in a two stage actuation scheme for microfluidic components. Electrical power is used to run pumps and valves for air to create pneumatic signals, and those pneumatic signals are used to control pumps and valves for fluids, based on otherwise-standard LOC approaches that control the analyte.

In accordance with embodiments of the invention, the external pneumatic connections are removed and the pneumatic signals are instead generated on chip.

The valve shown in FIGS. 2A and 2B comprises three main sections, namely a positive pressure control section 100a, a fluidic valve section 100b, and a negative pressure control section 100c. The pressure control sections 100a, 100c comprise electrostatically controlled check valves.

The fluidic valve section 100b has ports 102, 103 for the fluid to be controlled. The pressure control sections 100a, 100c have ports 104, 105 for connection to respective sources of positive and negative pressure.

In one embodiment, the valve is built up of a photopatternable epoxy layers 110, such as SU-8 or KMPR™, on a glass substrate 106 as described in our co-pending application entitled “A method of making a microfabricated device” filed on even date herewith, the contents of which are herein incorporated by reference.

The stack of PDMS layers define membranes 112, 114, 116 and chambers 118, 120, 122 separated by walls 127, 129 and internally divided by barriers 124, 126, 128 selectively engaging the membranes 112, 114, 116 to control fluid.

A control chamber 130 is formed below the membrane 114 and secondary chambers 132, 134 are formed below the membranes 112, 116.

A microfluidic channel 136 establishes communication between secondary chamber 132 and the left side of chamber 118.

A microfluidic channel 140 establishes communication between the chamber 120 and the left side of chamber 118. A microfluidic channel 140 establishes communication between the right side of chamber 118 and the control chamber 130. A microfluidic channel 142 establishes communication between the control chamber 142 and the left side of chamber 122. A microfluidic channel 138 establishes communication between the left side of chamber 122 and the secondary chamber 134.

The positive and negative pressure control sections 100a, 100c act as check valves, which operate generally in the manner described in our co-pending application entitled “An Integrated Microfluidic Check Valve” filed on even date herewith, the contents of which are herein incorporated by reference. However, they are arranged in reverse orientation, in that the positive pressure applied to pressure control section 104 would normally keep the valve closed. Electrostatic actuators are used to force the check valves into the open position.

Electrodes 144a, 144b and 146a, 146b define the electrostatic actuators within the secondary chambers 132, 134. The tracks to these electrodes can be incorporated in the structure in the manner described in our co-pending application referred to above.

The central fluidic valve 100b is controlled by applying positive and negative pressure to the control chamber 130, which alternately restores and deflects the membrane 114 in a similar manner to the valve described with reference to FIGS. 1A and 1B. However, unlike the prior art, the pneumatic signals are generated within the device by pressure control sections 100a and 100c and applied to the control chamber 130 via microfluidic channels 140, 142.

When it is desired to open the fluidic valve 100c, an electric signal is applied to the electrodes 146a, 146b to electrostatically deflect the membrane 116 downwards allowing negative pressure from negative pressure port 105 to reach the control chamber 130, as a result of which the membrane 114 deflects downwardly to open the valve 100b by allowing communication between the ports 102, 103.

When it is desired to close the fluidic valve, the signal to electrodes 146a, 146b is removed, allowing the membrane 116 to revert to the closed position. A signal is applied to the electrodes 144a, 144b to deflect the membrane 112 downwardly, thus allowing positive pressure from port 104 to be applied to the control chamber 130. The positive pressure restores the membrane 114 to the non-deflected position and closes the valve 100b.

When the valve 100b is in the closed position and positive pressure is applied to the control chamber 130, this pressure is applied through channels 142, 138 to secondary chamber 134, thereby re-inforcing the closure of the membrane 116. Likewise, when the valve 100b is in the open position, the negative pressure in the control chamber 130 tends to restore the membrane 112 to it non-deflected position. It will be noted that as a result of the channel 136, secondary chamber 132 remains at the same pressure as the positive pressure source, and as a result of the channel 138 secondary chamber 134 remains at the same pressure as the control chamber 130. The positive and negative control sections act as semi-active check valves.

It will been seen in this manner how the operation of the fluidic valve section 100b can be controlled by pneumatic signals generated on chip from electrical signals. All that is required is a source of positive and negative pressure.

It is legitimate to ask why the electrostatic actuators are not used to control the membrane 114 of the main valve directly. There are many situations where it is undesirable for the controlled fluid (water, other liquid, gas) to come into contact with the electrodes or operative parts of the valve. The design of the check-valves exposes their working fluid to the electrodes. In the case of air, which is insulating, this is not an issue. However, for conducting fluids, operation of the electrostatic electrodes will be limited by reactions with the working fluid. These reactions involve a wide range of potential effects (electro-osmotic flow, electrophoresis, electrochemical reactions). However, likely most critical, is electrolysis, which would severely limit the voltages that could be applied, making the forces available from electrostatic actuation insignificant.

With additional microfabrication steps, the electrodes could both be passivated to prevent steady-state current exchange with the liquid. However, this would still leave capacitively coupled currents. Additionally, even in the steady-state, conducting liquids will undergo charge separation as charged ions migrate to their respective electrodes.

Under the current microfabrication process, the pneumatic channels do not have homogeneous walls. This is not significant when routing air. However, adsorption/absorption is a significant issue in the design of chemical and molecular biology protocols. Handling this problem is complicated when the channel and chamber walls are not homogeneous. Although an additional polymer layer could be introduced to create a floor for the pneumatic layer, this introduces additional fabrication steps and so increases costs. The approach outlined above limits the liquid to those channels with homogeneous walls.

Air has a much lower viscosity then water, and therefore generally flows more quickly. It can therefore be advantageous to use a two stage actuation scheme, because the pneumatic components require much smaller hydraulic diameters.

A hybrid approach is also possible, wherein a semi-active check-valve is used to control a positive pressure supply, and electrodes are placed directly beneath the fluidic membrane instead of a negative pressure supply. This approach eliminates the need to generate and distribute a negative pressure supply, while still providing controls to both force the valve both open and closed.

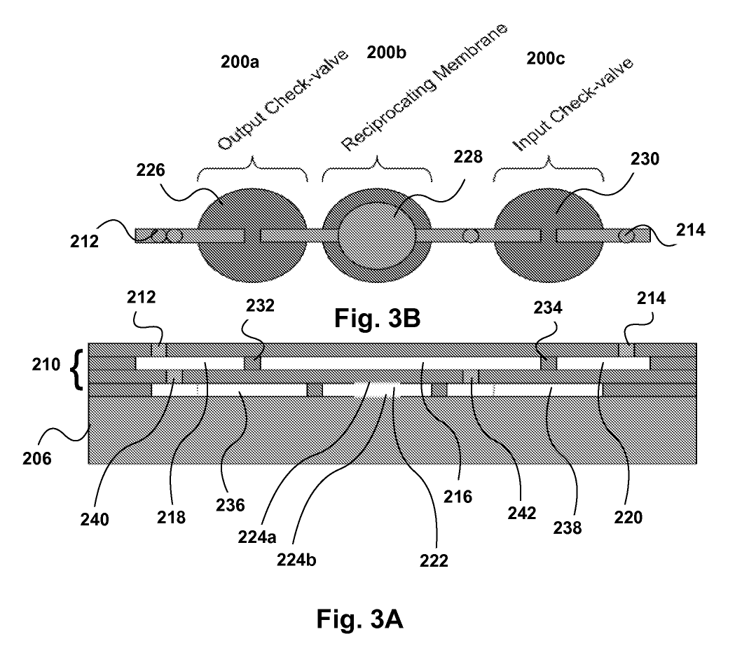

FIGS. 3A and 3B show an embodiment of a pump with an electrostatic actuator. Like the embodiment shown in FIGS. 2A, 2B, the pump comprises a stack of photopatternable epoxy layers 210 on a silicon substrate 206. The pump comprises three main sections, namely an output check valve 200a, a reciprocating membrane section 200b, and an input check valve 200c. The input and output check valves operate in the manner described in our co-pending application entitled “An Integrated Microfluidic Check Valve” filed on even date herewith, the contents of which are herein incorporated by reference.

The pump has an outlet port 212 and an inlet port 214, a main chamber 216 with peripheral subchambers 218, 220 on either side thereof.

Membranes 226, 230 co-operate with barriers 232, 234 to open and close the communication between the peripheral subchambers and the main chamber 216.

Secondary chambers 236, 238 lie below membranes 226, 230 co-operating with barriers 232, 234.

Microfluidic channels 240, 242 establish communication between secondary chambers 236, 238 and peripheral subchamber 218, and chamber 216 respectively.

In operation, an electrostatic actuator formed by electrodes 224a, 224b in control chamber 222 alternately reciprocates the membrane 200b. When the membrane 216 is flexed upwards, the pressure in the chamber increases, thereby expelling the working fluid through the output check valve 100a. When the membrane 216 is flexed downwards, the pressure in the chamber 216 decreases, thereby drawing in working fluid from the input check valve 200c. In this manner, flow through the pump can be assured by applying electrostatic signals to the electrostatic actuator.

If the working fluid is air, the pump can be used as an on-chip device to generate pneumatic signals within a lab on a chip, for example, or to provide the source of pressure for a valve of the type shown in FIGS. 2A-2B.

Embodiments of the invention can be used in lab-on-chip (LOC) devices. Lab-on-chip (LOC) devices integrate several chemical, molecular biology, or medical steps on a single chip. The approach is characterized by two advantages. First, LOC devices deal with the handling of extremely small fluid volumes, and so are offer a way to reduce costs by reducing the use of expense reagents. Second, LOC devices combine sequences of steps, either in series or parallel, and so offer a way to automated labour intensive testing and diagnostics. Currently available commercially, there are LOC devices for performing blood chemistry analysis on for detecting pathogens by their DNA.

The devices described may be used a wide range of chemical and medical diagnostic applications. For example, current technologies using simple glass-PDMS-glass chips are capable of performing complicated DNA analysis, such as sample preparation, amplification (PCR), and detection (electrophoresis).

Several chemical and medical applications are currently being developed based on a technology involving three layers (glass-PDMS-glass). Embodiments of the invention could be applied to these applications.

Additionally, embodiments of the invention might use three layers of glass (glass-glass-PDMS-glass). The additional glass layer may be used to insulate the fluid layer passing within the valve from the PDMS membrane over as much area as possible. The only regions where the fluids come into contact with the PDMS are at the valves.

Embodiments of the invention are closely aligned with modern microfabrication methods. Embodiments of the invention work with existing fabrication methods using standard semiconductor manufacturing equipment, which is compatible with high-volume manufacturing.

Embodiments of the invention are compatible with existing LOC valve and pump designs. Check-valves can replace the inlet and outlet valves of known LOC pumps, and those pumps will continue to work. Embodiments of the invention therefore complement existing LOC practices, and add value to those processes. By working with and simplifying existing LOC designs, the invention services to reduce costs.

We claim:

1. An integrated microfluidic device, comprising:
at least one active element controlled by pneumatic signals; and
at least one electrostatic actuator integrated in said device for generating the pneumatic signals within the device.

2. The integrated microfluidic device of claim 1, further comprising at least one port for connection to a respective external source of pressure, and wherein said at least one electrostatic actuator controls a valve to generate said pneumatic signals from said respective external source of pressure.

3. The microfluidic device of claim 2, wherein said valve comprises a first chamber having inlet and outlet ports, communication between said inlet and outlet ports being selectively opened and closed by a membrane, and a second chamber wherein said membrane forms at least part of a wall thereof, said second chamber containing said electrostatic actuator to displace said movable member between open and closed positions.

4. The integrated microfluidic device of claim 2, comprising a first said port providing a source of positive pressure and a second said port providing a source of negative pressure, a first said electrostatic actuator controlling a first valve to apply said positive pressure to said active element and a second said actuator controlling a second valve to apply said negative pressure to said active element.

5. The integrated microfluidic device of claim 4, wherein said active element comprises a fluidic valve having inlet and outlet ports, and a fluidic valve membrane controlled by said pneumatic signals to open or close a flow path between said inlet and outlet ports.

6. The integrated microfluidic device of claim 5, wherein said fluidic valve membrane is actuated by pressure variations within a chamber closed by said valve membrane, said chamber being in fluid communication with said respective first and second valves through microfluidic channels.

7. The integrated microfluidic device of claim 1, wherein said active element and said at least one electrostatic actuator are integrated into a stack of structural polymer layers.

8. The integrated microfluidic device of claim 7, wherein the structural polymer layers are photo patternable epoxy.

9. The integrated microfluidic device of claim 1, further comprising an electrostatically operated pump integrated within the device to provide at least one pressure source.

10. The integrated microfluidic device of claim 8, wherein the pump comprises a first chamber having an electrostatically displaceable membrane forming a wall thereof, and membrane-operated check valves at inlet and outlet ports thereof.

11. The integrated microfluidic device of claim 10, further comprising a second chamber adjacent said first chamber and containing a said electrostatic actuator to reciprocate said electrostatically displaceable membrane and thereby produce a pumping action.

12. The integrated microfluidic device of claim 7, wherein said stack of structural polymer layers is mounted on a CMOS substrate.

13. The integrated microfluidic device of claim 1, which is constructed of layers of glass and polydimethylsiloxane.

14. The integrated microfluidic device of claim 1, which is constructed of a stack of polymer layers.

15. The integrated microfluidic device of claim 13, wherein the polymer layers are bonded together.

16. The integrated microfluidic device of claim 13, wherein the polymer layers are laminated together.

17. The integrated microfluidic device of claim 1, comprising multiple said active elements and multiple said electrostatic actuators integrated within said device.

18. An integrated microfluidic device, comprising:
a first chamber having inlet and outlet ports and a barrier;
a membrane forming a wall of the first chamber co-operating with said barrier to open and close fluid flow between said inlet and outlet ports;
a second chamber having a wall thereof formed by said membrane; and
an electrostatic actuator within said chamber to deflect said membrane to selectively permit and prevent fluid flow between said inlet and outlet ports.

19. The integrated microfluidic device of claim 18, wherein said second chamber is in fluid communication with said first chamber via a microfluidic channel.

20. The integrated microfluidic device of claim 18, wherein the first and second chambers are defined within a stack of structural polymer layers.

21. An integrated microfluidic pump, comprising:
a first chamber having an electrostatically deflectable membrane forming a wall thereof; and
membrane-operated check valves at inlet and outlet ports thereof.

22. The integrated microfluidic device of claim 20, further comprising a control chamber adjoining said first chamber and containing a said electrostatic actuator to reciprocate said electrostatically displaceable membrane and thereby produce a pumping action.

23. The integrated microfluidic device of claim 21, wherein said first chamber comprises a main subchamber having said electrostatically displaceable membrane forming a wall thereof, peripheral subchambers provided with respective inlet and outlet ports on either side thereof; respective barriers separating said peripheral subchambers and said main subchamber, and pneumatically displaceable membranes co-operating with said barriers to provide said check valves.

24. The integrated microfluidic device of claim 23, further comprising second and third chambers adjoining said respective peripheral subchambers and in fluid communication therewith via microfluidic channels.

25. The integrated microfluidic device of claim 21, further comprising a second chamber adjoining said first chamber and containing said electrostatic actuator.

26. A method of controlling an active element of an integrated microfluidic device, comprising:
generating pneumatic signals with an electrostatic actuator within the device; and
controlling operation of the active element with the pneumatic signals.

27. The method of claim 26, wherein the electrostatic actuator controls access to an external pressure source.

28. The method of claim 26, wherein the electrostatic actuator operates a pump integrated into the device to create at least one internal pressure source from ambient pressure.
